(19) United States
(12) Patent Application Publication
(10) Pub. No.: US 2010/0188422 A1
(43) Pub. Date: Jul. 29, 2010

(54) DISPLAY DEVICE AND DISPLAY SYSTEM

(75) Inventors: Tomohisa Shingai, Kawasaki (JP); Hideki Koyama, Kawasaki (JP); Tokimori Tomita, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/751,654

(22) Filed: Mar. 31, 2010

Related U.S. Application Data
(63) Continuation of application No. PCT/JP2007/070363, filed on Oct. 18, 2007.

(51) Int. Cl. G09G 5/00

(52) U.S. Cl. 345/647

(57) ABSTRACT

A display device includes a display part that displays an image; and a control part that causes the display part to perform a bending motion in accordance with the display image, the control part is configured to cause the display part to perform a bending motion in accordance with an image so as to further increase the degree of attention, the control part causes the display part to perform a bending motion by driving an actuator attached to the display part, and the display part is bent into various shapes by attaching a plurality of actuators to the display part and causing the control part to selectively drive the plurality of actuators.

### CROSS-REFERENCE TO RELATED APPLICATIONS

This application is a continuation application and is based upon PCT/JP2007/070363, filed on Oct. 18, 2007, the entire contents of which are incorporated herein by reference.

### FIELD

The embodiments discussed herein are related to a display device and a display system including a flexible display element, such as flexible electronic paper, and in particular, to a display device and a display system including a display element capable of being bent.

### BACKGROUND

On paper, as an advertising/display medium, advertising content and display content are printed in advance, and therefore, the advertising content and the display content cannot be changed. When the advertising content and display content has ended, the paper on which the advertising content and display content are printed is discarded.

In recent years, a flexible display element, such as electronic paper that is thin and flexible and in which display content can be rewritten, has been developed. It is possible to increase the degree of attention compared to the case where conventional paper is used by displaying the advertising content on such a flexible display element instead of posting up paper on which the advertising content and the display content are printed in advance and by rewriting an image in accordance with the change in circumstances.

Japanese Laid-open Patent Publication No. 2003-114635 describes a paper-like information display medium that is thin and flexible and an information providing method and an information providing system using the same, and also describes a configuration that provides information timely and meticulously by distributing information data while “taking time and place into consideration” onto the information display, as an advertisement hanging from the ceiling of a train or bus.

International Publication Pamphlet No. WO2005/024774 describes a method of supplying data and electric power to an information display medium.

Japanese Laid-open Patent Publication No. 2003-280546 describes an information display element capable of being bent into a predetermined shape by providing an actuator to an information display element that is thin and flexible.

### SUMMARY

According to an aspect of the embodiments, a display device includes: a display part that displays an image; and a control part that causes the display part to bend in accordance with the display image.

The object and advantages of the embodiments will be realized and attained by means of the elements and combination particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A is a diagram illustrating a configuration of a display system in an embodiment;

FIG. 1B is a diagram explaining a bending motion of a display device in the embodiment;

FIG. 1C is a block diagram illustrating a functional configuration of the display system;

FIG. 2 is a diagram explaining a modified example of a bending motion of the display device;

FIG. 3 is a diagram explaining a modified example of a bending motion of the display device;

FIG. 4 is a diagram explaining a modified example of an arrangement of actuators of the display device;

FIG. 5 is a diagram explaining a modified example of an arrangement of actuators of the display device;

FIG. 6A is a diagram explaining an example of a bending motion that can be realized by the arrangement of the actuators in FIG. 4 and FIG. 5;

FIG. 6B is a diagram explaining an example of a bending motion that can be realized by the arrangement of the actuators in FIG. 4 and FIG. 5;

FIG. 6C is a diagram explaining an example of a bending motion that can be realized by the arrangement of the actuators in FIG. 4 and FIG. 5;

FIG. 6D is a diagram explaining an example of a bending motion that can be realized by the arrangement of the actuators in FIG. 4 and FIG. 5;

FIG. 6E is a diagram explaining an example of a bending motion that can be realized by the arrangement of the actuators in FIG. 4 and FIG. 5;

FIG. 6F is a diagram explaining an example of a bending motion that can be realized by the arrangement of the actuators in FIG. 4 and FIG. 5;

FIG. 6G is a diagram explaining an example of a bending motion that can be realized by the arrangement of the actuators in FIG. 4 and FIG. 5;

FIG. 7A is a diagram illustrating a structure of a piezoelectric actuator including a monomorph structure;

FIG. 7B is a diagram illustrating a bent state of a piezoelectric actuator including the monomorph structure;

FIG. 7C is a diagram illustrating a bent state of a piezoelectric actuator including the monomorph structure;

FIG. 8A is a diagram illustrating a structure of a piezoelectric actuator including a bimorph structure;

FIG. 8B is a diagram illustrating a bent state of a piezoelectric actuator including the bimorph structure;

FIG. 8C is a diagram illustrating a bent state of a piezoelectric actuator including the bimorph structure;

FIG. 8D is a diagram illustrating a bent state of a piezoelectric actuator including the bimorph structure;

FIG. 9 is a diagram illustrating a configuration of an actuator drive part for making variable an amount of bending of an actuator;

FIG. 10A is a diagram illustrating an example of a drive signal of the actuator;

FIG. 10B is a diagram illustrating an example of a drive signal of an actuator;

FIG. 10C is a diagram illustrating an example of a drive signal of the actuator;

FIG. 10D is a diagram illustrating an example of a drive signal of the actuator;

FIG. 11A is a diagram illustrating an example of a display image in a modified example in which a Fresnel lens is arranged on the front surface of a display device;

FIG. 11B is a diagram illustrating a modified example in which a Fresnel lens is arranged on the front surface of a display device;

FIG. 12 is a diagram explaining a modified example in which an actuator that bends in accordance with a display image is changed;

FIG. 13A is a diagram illustrating a configuration of a display device in which data is stored in a storage part in an off-line manner;

FIG. 13B is a diagram illustrating a configuration of a display device in which data is transmitted from an external transmission part to a storage part via a wired interface of a holding part;

FIG. 13C is a diagram illustrating a configuration of a display device in which data is transmitted from an external transmission part to a storage part via a wireless interface;

FIG. 14A is a diagram illustrating a configuration in which a sensor is provided in a display device;

FIG. 14B is a diagram illustrating a configuration of a display device in which a sensor is provided externally and a sensor detection signal is transmitted to a control part via a wired interface of a holding part;

FIG. 14C is a diagram illustrating a configuration of a display device in which a sensor is provided externally and a sensor detection signal is transmitted to a control part via a wireless interface;

FIG. 15A is a diagram illustrating a configuration in which a speaker is provided in a display device;

FIG. 15B is a diagram illustrating a configuration in which a speaker is provided externally and a voice stream is transmitted from a control part to the speaker via a wired interface of a holding part;

FIG. 15C is a diagram illustrating a configuration in which a speaker is provided externally and a voice stream is transmitted from a control part to the speaker via a wireless interface;

FIG. 16 is a diagram illustrating a configuration in which electric power is supplied to a power source of a display device by a high frequency wireless signal for electric power;

FIG. 17 is a diagram illustrating a configuration in which a power source is provided externally and electric power is supplied to a display device via a wired interface of a holding part;

FIG. 18 is a diagram illustrating a configuration in which a power source, a control part, and an actuator drive part are provided externally and an image rewrite signal and an actuator drive signal are supplied to a display part via a wired interface of a holding part.

### DESCRIPTION OF EMBODIMENTS

Embodiments are explained below with reference to the drawings.

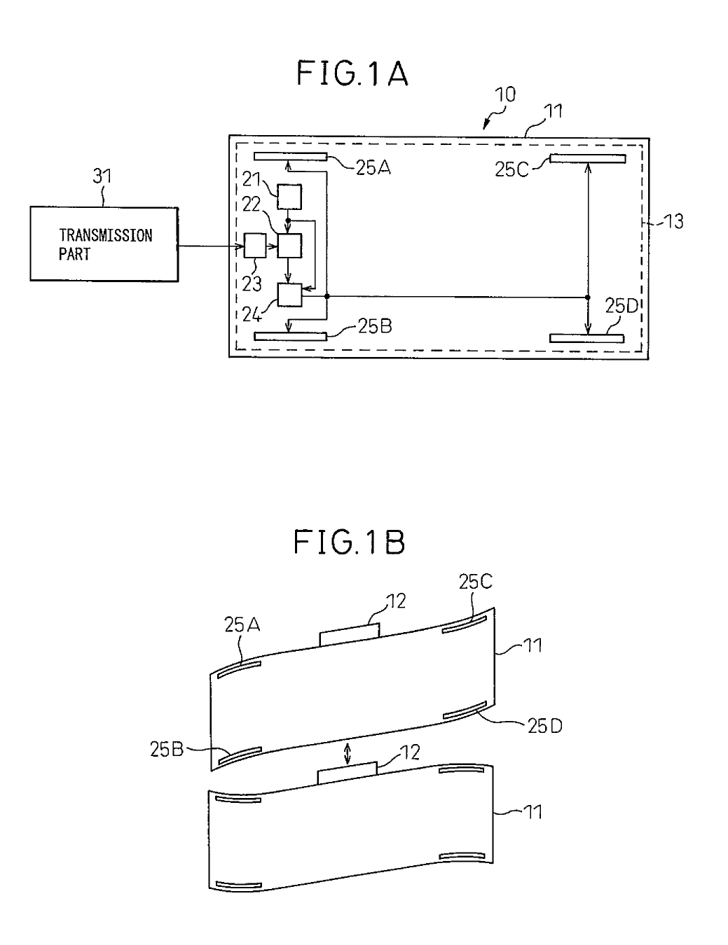

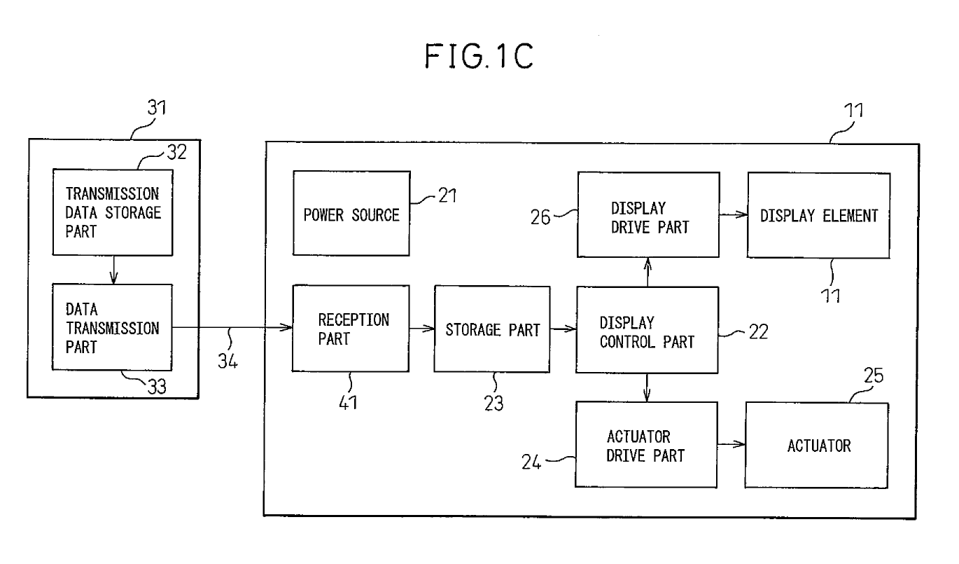

FIG. 1A is a diagram illustrating a configuration of a display system in an embodiment.

As illustrated in FIG. 1A, the display system in the embodiment includes a display device 10 and a transmission part 31. The display device 10 includes a flexible display element 11 including a display screen 13, a thin power source 21, a display control part 22, a storage part 23 that stores image data and data of bending motion corresponding to the image data, an actuator drive part 24, and actuators 25A to 25D. As will be described later, the display device 10 also includes a display drive part that drives the flexible display element 11, however, it is not illustrated schematically here. This also applies in other drawings. The thin power source 21, the display control part 22, the storage part 23, the actuator drive part 24 and the actuators 25A to 25D are provided on the flexible display element 11.

The transmission part 31 transmits image data and data of bending motion corresponding to the image data to the display device 10. The image data and data of bending motion transmitted from the transmission part 31 are stored in the storage part 23.

The data of bending motion includes data about a number for identifying an actuator(s) when a plurality of actuators are provided, a bending mode that specifies the type of bending motion, timing of bending motion, etc.

As the flexible display element 11, it is also possible to use a thin liquid crystal display or EL display, however, electronic paper that does not require electric power, except when rewriting, is preferable when the frequency of rewriting is low, such as in an advertising display. In particular, a cholesteric liquid crystal color electronic paper that is light in weight and capable of a bright color display is most preferable. The cholesteric liquid crystal display device is widely known and described in, for example, patent document 2, and therefore, its detailed explanation is omitted here.

Either way, the flexible display element 11 has flexibility, i.e., the flexible display element 11 is flexible and desirable to be in the form of a sheet. In the following explanation, it is assumed that the flexible display element 11 is electronic paper.

The display control part 22 reads image data and data of bending motion stored in the storage part 23, selects a kind of image, and displays the image on the flexible display element (electronic paper) 11 at a display timing associated with the image and at the same time, controlling the actuator drive part 24 in accordance with the data of bending motion associated with the image. In response to this, the actuator drive part 24 drives the actuators 25A to 25D. The power source 21 supplies electric power to each component.

The power source 21, the display control part 22, the storage part 23 and the actuator drive part 24 are light and thin and provided on the backside of the flexible display element 11. The display drive part, not illustrated schematically, is also light and thin and provided on the backside of the flexible display element 11.

As the actuators 25A to 25D, it is also possible to use those of normal electromagnetic type and provide separately from the flexible display element 11, however, an actuator in the form of a sheet is preferable and provided on the backside of the flexible display element 11. It is possible to realize a display and bending features of the flexible display element 11 while allowing the flexible display element 11 to remain in the form of a thin sheet by using an actuator in the form of a strip.

FIG. 1B is a diagram explaining the bending motion of the flexible display element 11. Reference numeral 12 represents a holding member for holding the flexible display element 11. The flexible display element 11 includes the four actuators 25A to 25D provided along the upper and lower edges, and therefore, the right and left sides are bent by driving them. Due to this, for example, it is possible to bring the flexible display element 11 into a wavy state as illustrated in FIG. 1B. Further, it is also be possible to bend the display element so as to form part of a cylinder. Furthermore, it is possible to cause the display element to perform a wavy motion by repeating turning on/off of the bending motion, and the degree of attention can be changed by changing the speed of the bending motion.

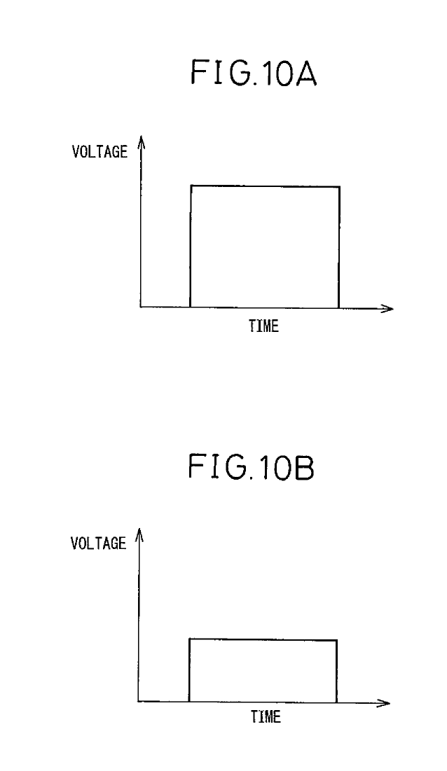

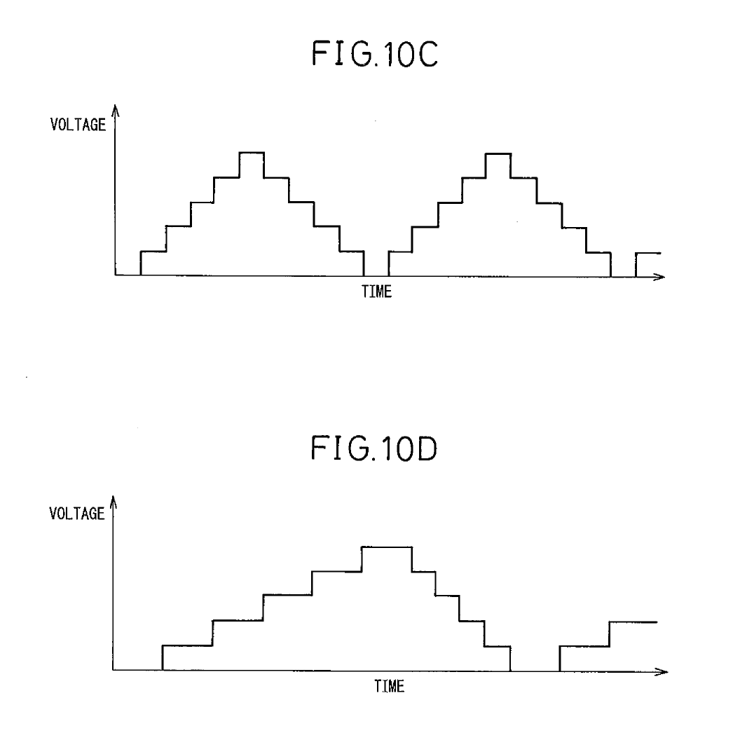

FIG. 10 is a block diagram illustrating a functional configuration of a display system in the embodiment. As illustrated in FIG. 10, the transmission part 31 includes a transmission data storage part 32 that stores image data and data of bending motion corresponding to the image data, and a data transmission part 33 that transmits the image data and data of bending motion read from the transmission data storage part 32 to the display device 10.

Reference numeral 34 represents a transmission path of image data and data of bending motion. As will be described later, there can be various modifications for the transmission path 34.

The display device 10 includes a reception part 41 that receives image data and data of bending motion transmitted from the transmission part 31, the storage part 23 that stores the received image data and data of bending motion, the display control part 22, the actuator drive part 24, the actuator 25 (25A to 25D), a display drive part 26, the flexible display element 11, and the power source 21.

To the part in relation to the image display of the part configured by the transmission data storage part 32, the data transmission part 33, the transmission path 34, the power source 21, the reception part 41, the storage part 23, the display control part 22, the display drive part 26, and the display part 13, the conventional configuration described in, for example, patent document 2, can be applied as it is. The present embodiment differs from the conventional example in that the transmission data storage part 32, the data transmission part 33, the transmission path 34, the reception part 41, the storage part 23, and the display control part 22 deal with data of bending motion and in that the actuator drive part 24 and the actuator 25 are provided.

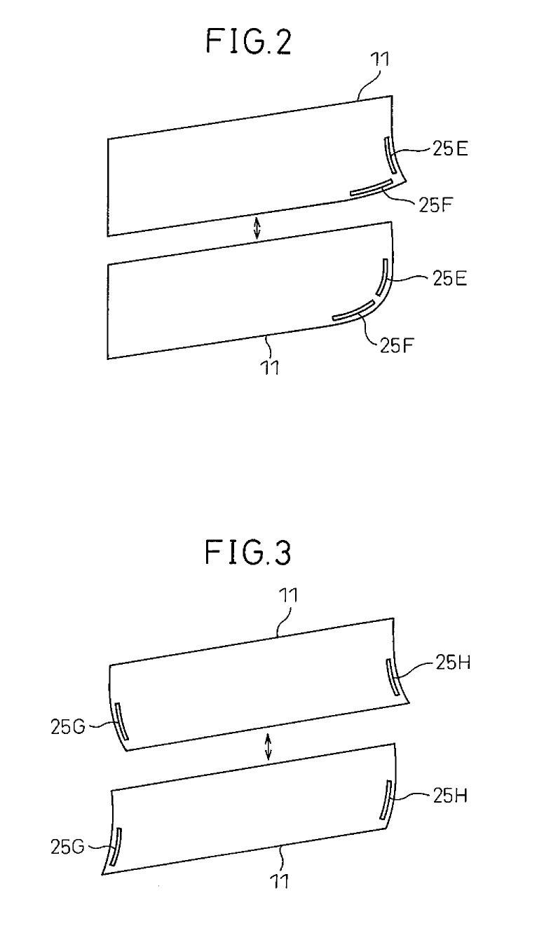

FIG. 2 and FIG. 3 are diagrams each illustrating a modified example of positions at which actuators are provided.

In FIG. 2, actuators 25E and 25F in the form of a strip are provided, respectively, on the vertical side and the bottom side near one corner of the flexible display element 11. By driving the actuators 25E and 25F, the one corner on the bottom side bends and the flexible display element 11 is brought into a state where the corner is turned up or turned down.

When the flexible display element 11 illustrated in FIG. 2 is used for advertisement, it is possible to increase the degree of attention and further magnify the advertising effectiveness by displaying a brand name, advertising phrase, sponsor name, etc., at the corner part of the flexible display element 11 at which the actuators 25E and 25F are provided.

By continuously repeating the bending motion, the one corner on the bottom side rocks back and forth. By repeating the bending motion at high speed, the corner will attract attention in a manner different from that when the bending motion is repeated at low speed.

In FIG. 3, actuators 25G and 25H in the form of a strip are provided in parallel with each other on both vertical sides of the flexible display element 11. By driving both the actuators 25G and 25H at the same time, the flexible display element 11 bends so as to be a part of a cylinder. If this bending motion is performed continuously, the bottom side rocks back and forth.

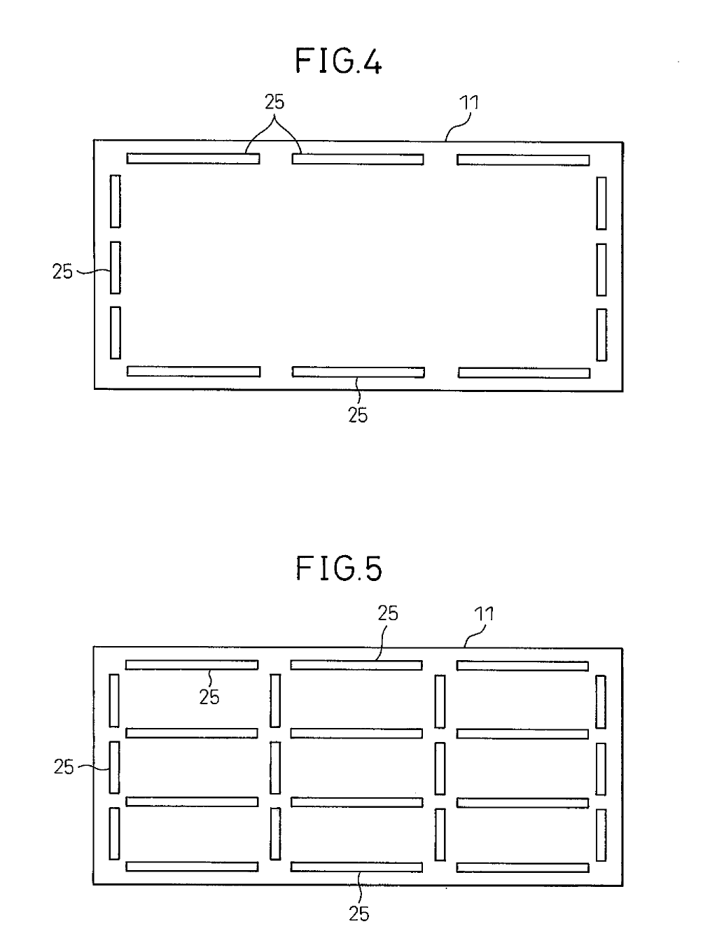

As illustrated in FIG. 4 and FIG. 5, it is also possible to provide more actuators 25 on the flexible display element 11. In the example in FIG. 4, the actuators 25 are provided along the four sides of the flexible display element 11 and all of the bending motions in FIG. 1B, FIG. 2 and FIG. 3 can be realized by selecting and driving the two or more actuators 25.

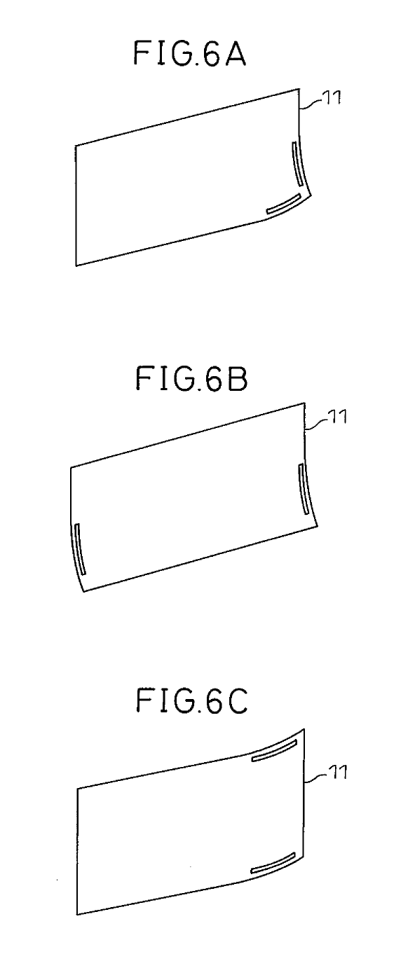

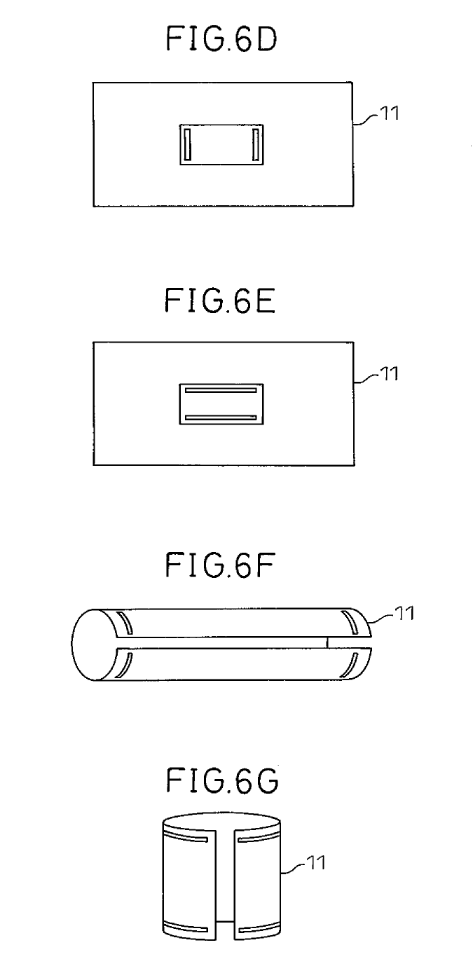

In the example in FIG. 5, the plurality of the actuators 25 are provided on the flexible display element 11 in the form of a grid. FIG. 6A to FIG. 6G show examples of the bending motions that can be realized by the arrangement of the actuators 25 in FIG. 5. In FIG. 6A to FIG. 6G, only the actuators that are driven are illustrated. FIG. 6D and FIG. 6E show the bending of the flexible display element 11 in FIG. 6B and FIG. 6C localized only in a part. In particular, if the bending is such as illustrated in FIG. 6F and FIG. 6G, it is possible to greatly impact the advertisement of canned beverages, etc.

Various bending states, in addition to those examples illustrated in FIG. 6A to FIG. 6G, can be realized by combining the actuators 25 to be bent. Further, when an actuator, the bending direction of which can be selected is used, it is possible to select a bending direction, and therefore, to realize even more bending states. No more explanation on the bending state is given here.

Next, an actuator in the form of a sheet is explained. As described above, when the present embodiment is realized, it is preferable to use an actuator in the form of a thin sheet. As an actuator in the form of a sheet having high utility, mention is made of, for example, a piezoelectric actuator including a monomorph/bimorph structure widely known as a piezoelectric element. Further, there is a thermal distortion actuator including a monomorph/bimorph structure, and an actuator can be used, which has a thickness of about 25 μm and capable of bending cholesteric liquid crystal color electric paper having a thickness of 300 μm, however, an piezoelectric actuator is more desirable from the standpoint of power consumption.

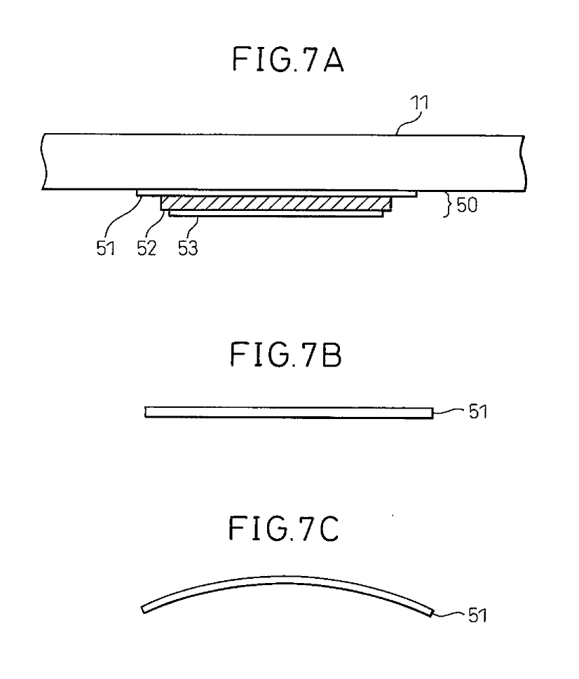

FIG. 7A is a diagram illustrating a structure of an actuator 50 including a monomorph structure that uses a plate-shaped piezoelectric element and FIG. 7B and FIG. 7C show its bent states.

As illustrated in FIG. 7A, the actuator 50 including a monomorph structure includes a lower electrode 51, a plate-shaped piezoelectric element 52 provided on the lower electrode 51, and an upper electrode 53 provided on the plate-shaped piezoelectric element 52, and is attached to the backside of the electronic paper 11 by the adhesion of the lower electrode 51 thereto. The thickness of the flexible display element (electronic paper) 11 is 300 μm, the thickness of a stainless plate constituting the upper electrode is 25 μm, and the thickness of the plate-shaped piezoelectric element 52 is 50 μm. A piezoelectric constant d31 is −300 pm/V and a piezoelectric applied voltage is 60 V. When a voltage of 60 V is applied, the electric field strength is 1.2 kV/mm and the stainless plate constituting the upper electrode bends at a radius of curvature of about 1 m, and in response to this, the electronic paper 11 also bends. FIG. 7B shows a state where no voltage is applied and the stainless plate constituting the upper electrode 51 is in a flat state. Because this actuator includes a monomorph structure, the direction of bending is only toward one side and when a voltage is applied, the stainless plate constituting the upper electrode 51 bends so as to form a convex shape, as illustrated in FIG. 7C.

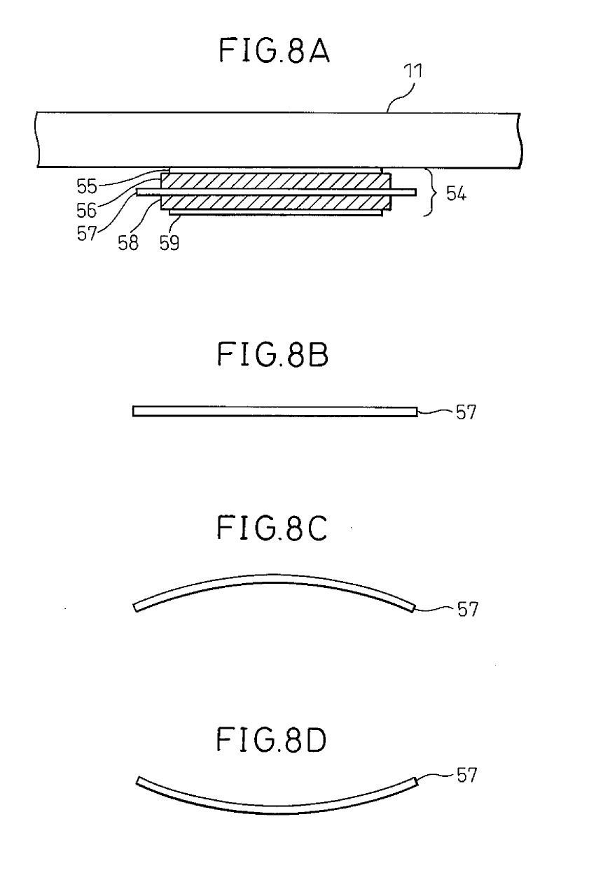

FIG. 8A is a diagram illustrating a structure of an actuator 54 including a bimorph structure that uses a plate-shaped piezoelectric element and FIG. 8B to FIG. 8D show its bent states.

As illustrated in FIG. 8A, the actuator 54 including a bimorph structure includes a common electrode 57 made of a stainless plate, a lower side plate-shaped piezoelectric element 56 provided on one side of the common electrode 57, an upper side plate-shaped piezoelectric element 58 provided on the other side of the common electrode 57, the lower electrode 51 provided on the lower side plate-shaped piezoelectric element 56, and an upper electrode 59 provided on the upper side plate-shaped piezoelectric element 58, and is attached to the backside of the electronic paper 11 by the adhesion of a lower electrode 55 etc. The thickness of the electronic paper 11 is 100 μm, the thickness of the stainless plate constituting the common electrode 57 is 25 μm, and the thickness of the lower side and upper side plate-shaped piezoelectric elements 56, 58 is 50 μm. The piezoelectric constant d31 is −300 pm/V and the piezoelectric applied voltage is 60 V. When a voltage of 60 V is applied, the stainless plate constituting the common electrode bends at a radius of curvature of about 1 m, and in response to this, the electronic paper 11 also bends. FIG. 8B shows a state where no voltage is applied and the stainless plate constituting the upper electrode 51 is in a flat state. Because this actuator includes a bimorph structure, it can bend to both sides and when a voltage is applied to the upper electrode 59, the upper electrode 59 bends so as to form a concave shape as illustrated in FIG. 8C and when a voltage is applied to the lower electrode 55, the upper electrode 59 bends so as to form a convex shape as illustrated in FIG. 8D.

If a piezoelectric element having excellent crystallinity, which is manufactured by the sol-gel method or RF sputtering method, is used as the plate-shaped piezoelectric elements 52, 56, 58 in the actuator 50 including a monomorph structure in FIG. 7A and the actuator 54 including a bimorph structure in FIG. 8A, the electric field strength is 18 kV/mm and the stainless plate bends at a radius of curvature of about 10 cm when a voltage of 900 V is applied, and therefore, it is possible to considerably bend the electronic paper 11 having a thickness of 300 μm.

When only the bending (on/off) of a plate-shaped piezoelectric element is controlled, complicated waveforms are not necessary to drive it, and it is only required to simply turn on/off a predetermined voltage using a drive transistor etc. provided in the actuator drive part 24. The drive power source of a display medium is about 30 V, for example, in the case of cholesteric liquid crystal, and if the voltage required to drive the actuator is about 60 V, it is possible to easily generate waves only by adding a publicly known voltage doubler output circuit to the drive power source of the display medium. When the above-mentioned piezoelectric element excellent in crystallinity is used and is considerably bent by applying a voltage of 900 V, it is necessary to provide a high voltage power source exclusive for the piezoelectric element.

It is also possible to control (1) the amount of bending and (2) the speed of bending of the plate-shaped piezoelectric element, in addition to only the bending (on/off), and in such a case, the amplitude of a voltage to be applied to the plate-shaped piezoelectric element and the rate of change in speed are controlled.

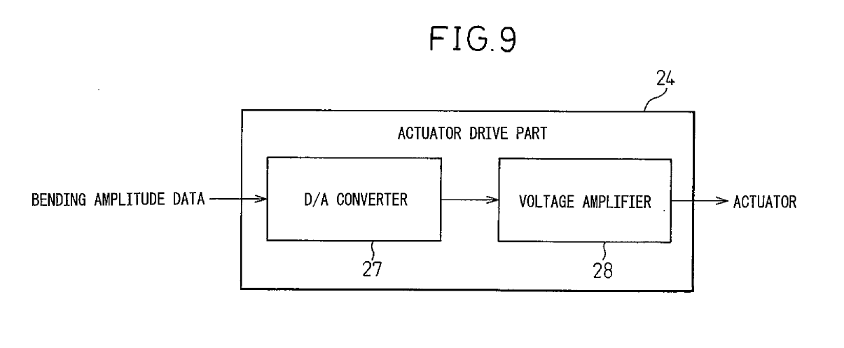

FIG. 9 is a diagram illustrating the configuration of the actuator drive part 24 when the amount of bending and the speed of bending are controlled. As illustrated in FIG. 9, the actuator drive part 24 includes a D/A converter 27 that receives bending amplitude data and issues an analog signal in accordance with the data, and a voltage amplifier 28 that amplifies the D/A converter 27 to generate a voltage to be applied to the actuator.

FIG. 10A to FIG. 10D show voltage waveforms to be applied to the electrode.

First, a case where (1) how much the element is bent, that is, the amount of bending is controlled is explained with reference to FIG. 10A and FIG. 10B. When the power source is turned on, “amplitude=0” is sent to the D/A converter 27 as data of bending motion and the piezoelectric drive voltage becomes 0 V. At this time, the piezoelectric element is in a flat state where it is not bent.

As illustrated in FIG. 10A, when the element is bent to the maximum amplitude at a certain timing, “amplitude=1” is sent to the D/A converter 27 as the bending amplitude data and the piezoelectrie drive voltage rapidly changes to the maximum output voltage (for example, 60 V). Due to this, the piezoelectric element is brought into a maximally bent state. While this voltage is being applied, the bent state of the piezoelectric element is maintained. During this period, almost no current flows, and therefore, its power consumption is very small. When the timing at which the state is returned to its original state is reached, “amplitude=0” is sent to the D/A converter 27 as the bending amplitude data and the piezoelectric drive voltage rapidly becomes 0 V, and therefore, the bent state is released and the piezoelectric element enters a flat state.

As illustrated in FIG. 10B, when the piezoelectric element is bent to half the maximum amplitude at a certain timing, “amplitude=0.5” is sent to the D/A converter 27 as bending amplitude data and the piezoelectric drive voltage rapidly changes to ½ of the maximum output voltage (for example, 30 V). Due to this, the piezoelectric element is brought into a state of being bent to half the maximum amount of bending and the bent state is maintained while the voltage is being applied. When the timing at which the state is returned to the original state is reached, “amplitude=0” is sent to the D/A converter 27 as bending amplitude data and the piezoelectric drive voltage changes to 0 V, and therefore, the bent state is released and the piezoelectric element is brought into the flat state.

Next, a case where (2) at which speed the element is bent, i.e., the bending speed is controlled is explained with reference to FIG. 10C and FIG. 10D. When the power source is turned on, “amplitude=0” is sent to the D/A converter 27 as data of bending motion and the piezoelectric drive voltage changes to 0 V. At this time, the piezoelectric element is in the flat state where the piezoelectric element is not bent.

When the piezoelectric element is bent gradually in a predetermined period of time to the maximum amplitude at a certain timing, as illustrated in FIG. 10C, “amplitude=0.2” is sent to the D/A converter 27 first as bending amplitude data and the piezoelectric drive voltage changes to ⅕ of the maximum output voltage (for example, 12 V). After the voltage is maintained for a period of ⅕ of a predetermined time, “amplitude=0.4” is sent to the D/A converter 27 and the piezoelectric drive voltage changes to ⅖ of the maximum output voltage (for example, 24 V). This is repeated and a predetermined time later, “amplitude=1.0” is sent to the D/A converter 27 and the piezoelectric drive voltage changes to the maximum output voltage (for example, 60 V). Due to this, the piezoelectric element is brought into the maximally bent state. When the timing at which the state is returned to the original state is reached, “amplitude=0.8” is sent to the D/A converter 27 as bending amplitude data and the piezoelectric drive voltage changes to ⅘ of the maximum output voltage (for example, 48 V). After this voltage is maintained for a period of ⅕ of the predetermined time, “amplitude=0.6” is sent to the D/A converter 27 and the piezoelectric drive voltage changes to ⅗ of the maximum output voltage (for example, 36 V). This is repeated and a predetermined time later, “amplitude=0” is sent to the D/A converter 27 and the piezoelectric drive voltage changes to 0 V, and therefore, the bent state is released and the piezoelectric element is brought into the flat state.

FIG. 10D shows a case where the piezoelectric drive voltage is changed to the maximum output voltage in double the time compared to the case in FIG. 10C, however, the voltage is changed from the maximum output voltage to 0 V in half the time (the same period of time as that in FIG. 10C).

There can be various modified examples for the control of the amount of bending and the bending speed. For example, when the bending speed is changed, control in which the amount of bending per step and the total amount of bending are changed, control in which one of the changes is such that the output voltage is changed rapidly to the final voltage as illustrated in FIG. 10A and FIG. 10B, etc., are possible.

Next, a modified example to further magnify the effect of display by bending is explained.

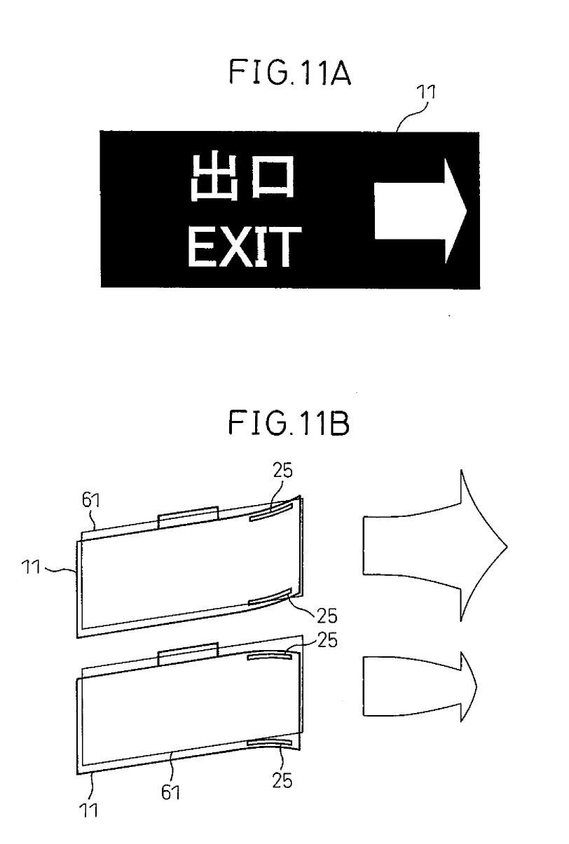

FIG. 11A and FIG. 11B are diagrams illustrating a configuration of a display system in a modified example. In this display system, by using a Fresnel lens 61 also in the display element device (electronic paper 13) 11, the visual change of a display image is enlarged optically.

As illustrated in FIG. 11B, the actuators 25 are provided along the upper side and the lower side near one of the ends of the flexible display element (electronic paper) 11 and the one of the sides of the flexible display element 11 can be bent to both sides. When this side part is bent, the distance between the display surface and the Fresnel lens 61 changes, and therefore, the expansion ratio of the displayed image changes considerably.

For example, in the case where a public sign, such as “EXIT” as illustrated in FIG. 11A, is displayed on the flexible display element 11, if an arrow indicating the direction of the exit is displayed at the side part, the size of the arrow is increased and decreased as illustrated in FIG. 11B, and thereby, the degree of attention is increased considerably.

In the example illustrated in FIG. 11A and FIG. 11B, by bending the part of the arrow indicating the exit, the appearance of the arrow, which is the most important target of attention, is changed (size is increased and decreased), and thus, the degree of attention is increased. In order to perform this motion of the flexible display element 11 including the actuators illustrated in FIG. 4 and FIG. 5, the positional information of the arrow part, as the position to be bent, and information about a bent shape (cylindrical shape the axis of which is parallel with the side), as the way it is bent, for example, information concerning turning on/off of bending at two-second intervals (in the case of an actuator including a bimorph structure, the reversal of the bending direction), as a bending timing, are associated with the display image and stored in the storage part 23. Conversion from these pieces of information into drive conditions of each actuator is performed by referring to a lookup table for conversion or by utilizing a conversion program of a microcomputer constituting the control part.

When an advertisement is displayed instead of a public sign, if a brand name, advertising phrase, or sponsor name, etc., is displayed at the part of the arrow in FIG. 11A, it is possible to obtain a high degree of advertising effectiveness.

If a display device capable of displaying a motion picture is used, it is possible to obtain the same effect by changing the size of the arrow to be displayed, however, because a motion picture is displayed, energy to be consumed is by far greater compared to the example illustrated in FIG. 11B, and therefore, not practical. Further, when a motion picture is displayed, if the speed of drawing is not sufficiently high, there arises a problem of flickering etc. in the display. According to the present embodiment, such a problem will not arise.

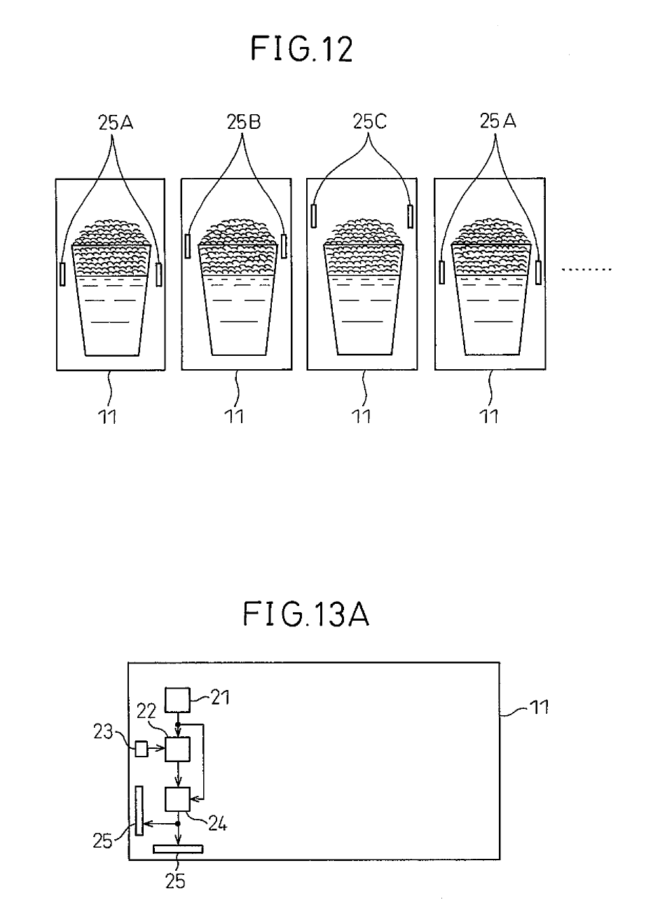

FIG. 12 shows an example to increase the degree of advertising effectiveness by controlling the positions of the actuators that bend of the flexible display element 11 including the actuators illustrated in FIG. 4 and FIG. 5, and the timing of bending so as to shift continuously.

FIG. 12 shows an example of advertisement of beer, in which the part of the froth is bent into a forwardly convex shape. Of the actuators provided along both sides, a set of the actuators that bend changes in order of 25A, 25B, and 25C as illustrated in FIG. 12 and this change is repeated. Due to this, the position at which the actuators bend shifts continuously upward and a visual effect that the froth seems moving is obtained and the degree of attention is increased. This technique is also effective when used in an image of waves that move toward the shore.

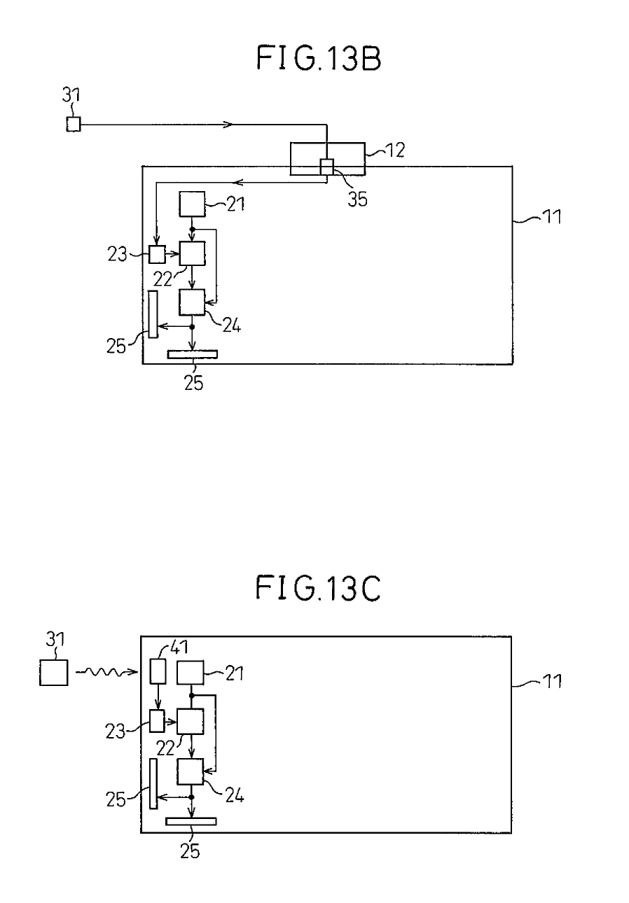

As illustrated in FIG. 1A, the image data and data of bending motion stored in the storage part 23 are transmitted from the transmission part 31, however, there can be various transmission systems. FIG. 13A to FIG. 13C are diagrams each illustrating an example of a transmission system of the image data and data of bending motion stored in the storage part 23. In FIG. 13A and FIG. 13B, the reception part 41 is omitted.

FIG. 13A is a diagram illustrating a configuration of a display device when image data and data of bending motion are transmitted in an offline manner to the storage part 23. The display device includes a wired interface, not illustrated schematically, receives the image data and data of bending motion from the transmission part 31 via the wired interface, and stores them in the storage part 23. After the image data and data of bending motion are stored in the storage part 23, the display device 10 (flexible display element 11) is installed at a desired position and used. When in use, the state of the wired interface is a disconnected state, and therefore, it is not possible to change the image data and data of bending motion stored in the storage part 23 while the display device 10 is installed.

FIG. 13B shows a configuration of a display system in which a wired interface 35 for receiving the image data and data of bending motion to be transmitted from the transmission part 31 to the storage part 23 is provided in the holding member 12 that holds the display device 11. With this configuration, it is possible to transmit the image data and data of bending motion from the transmission part 31 to the storage part 23 in a state where the display device 10 (flexible display element 11) is installed, and to change the image data and data of bending motion stored in the storage part 23 at any time.

FIG. 13C shows a configuration of a display system in which image data and data of bending motion are transmitted from the transmission part 31 to the storage part 23 using a wireless interface. The data transmission part 33 of the transmission part 31 is a wireless transmission part and outputs image data and data of bending motion as a wireless signal. The reception part 41 of the display device 10 is a wireless reception part and receives a wireless signal of the image data and data of bending motion transmitted from the transmission part 31 and stores it in the storage part 23. With this configuration also, it is possible to transmit the image data and data of bending motion from the transmission part 31 to the storage part 23 even in a state where the display device 10 (flexible display element 11) is installed, and to change the image data and data of bending motion stored in the storage part 23 at any time.

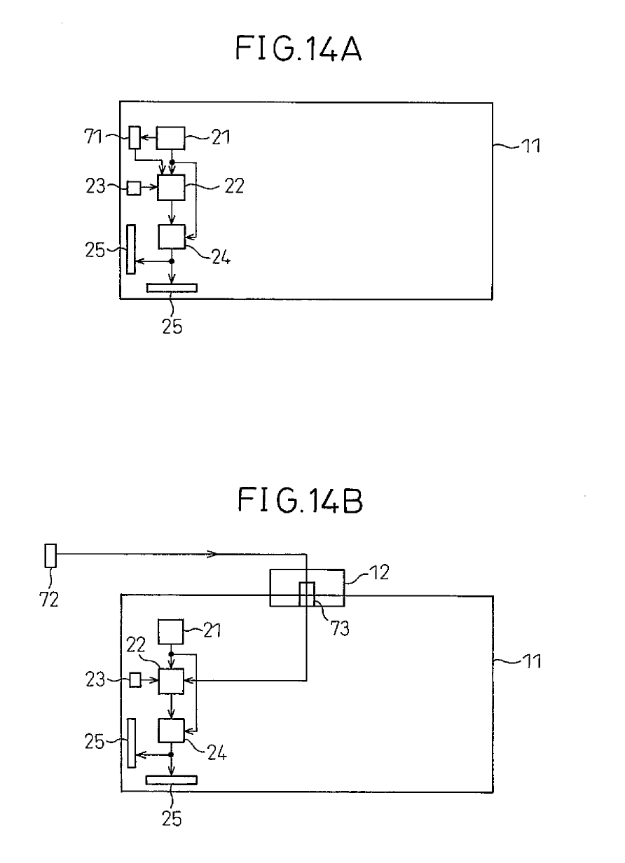

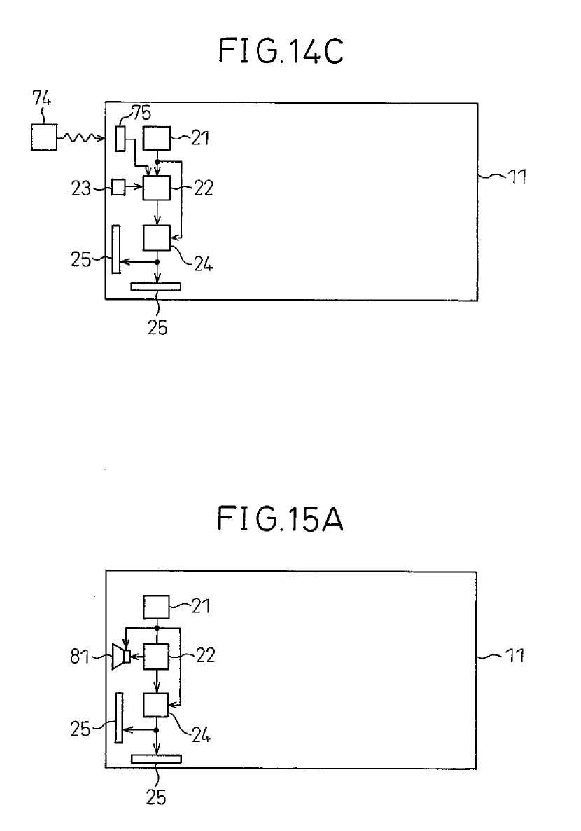

FIG. 14A to FIG. 14C are diagrams each illustrating a configuration of a modified example in which the display system in the embodiment is combined with a sensor. In addition to these modified examples, there can be various modified examples according to the position at which a sensor is provided.

FIG. 14A is an example in which a sensor 71 is provided in the display device 10 (flexible display element 11). A detection signal of the sensor 71 is sent to the control part 22.

FIG. 14B is an example in which a sensor 72 is provided in the vicinity of the outside of the display device 10. A detection signal of the sensor 72 is sent to the control part 22 via a wired interface 73 provided in the holding member 12 that holds the flexible display element 11.

FIG. 14C shows a configuration in which a detection signal is transmitted to the control part 22 from a sensor 74 using a wireless interface. The sensor 74 includes a wireless transmission part that transmits a detection signal in a wireless manner as well as a sensor part. The display device 10 includes a wireless reception part 75 that receives a wireless detection signal and sends the received detection signal to the control part 22.

The sensors 71, 72, 74 are each sensors that detect, for example, the approach of a passerby. When detecting the approach of a passerby within a predetermined distance from the display device 10 (flexible display element 11), the sensor outputs a detection signal to the control part 22. Triggered by this signal, the control part 22 causes the flexible display element 11 to bend as well as suddenly displaying an image on the screen on which nothing is displayed up to that time or changing a display image, and thus, magnifying the advertising effectiveness. When a passerby approaches the display device, an image that is not displayed up to that time is suddenly displayed on the display device or the displayed content changes, and therefore, the probability of attracting attention of the passerby is by far greater compared to an image displayed on paper. Such a display device is arranged along a roadway and the advertising display displayed ahead of a passerby changes sequentially when the passerby moves along the roadway or the advertising display bends in accordance with the movement of the passerby presents a magnificent spectacle, and therefore, the advertising effectiveness is very high.

In the configuration in FIG. 14A, because the sensor 71 is provided in the display device 10 (flexible display element 11), it is required only to arrange the display device 10 (flexible display element 11) and the holding method is not limited, and therefore, its installation is easy. However, the distance within which the sensor 71 can detect the approach of a passerby without fail is limited, and therefore, there is a problem that the approach of a passerby cannot be detected unless the passerby comes very close to the flexible display element 11. In contrast to this, in the configuration in FIG. 14B, it is possible to appropriately arrange the sensors 72, 74 at desired positions, and therefore, it is possible to arbitrarily set a position at which the image display and the bent state are changed when a passerby approaches. However, in the case of FIG. 14B, it is necessary to provide the interface 73 in the holding part 12 and there is a problem that the holding part of the conventional paper medium cannot be used. With the configuration in FIG. 14C, the above-mentioned problems do not arise, however, it is not possible to arrange the sensor 74 at too great a distance because of the communication range available.

In recent years, an identification device called RFID is widely spread. The identification device outputs a wireless signal for excitation from a base apparatus, and the RFID generates electric power from the wireless signal and activates an internal circuit using the electric power and transmits stored data to the base apparatus. The base apparatus takes out information stored in the RFID from the received signal.

For example, in a limited space, such as an amusement park and zoo, with visitors' permission, RFIDs that store attribute data, such as visitor's sex and age, are attached to the visitors, and the sensors 71, 72, 74 are used as the base apparatus. The sensors 71, 72, 74 output wireless signals at all times and when a visitor carrying the RFID approaches the sensor, the sensor acquires the attribute data from the RFID and causes the flexible display element 11 to display an appropriate image in accordance with the data or to rewrite the display image so that an appropriate image is displayed, and further, to perform a bending motion in accordance with the display image. When a visitor approaches, the flexible display element 11 changes the display image and further performs a bending motion, and therefore, it is possible to display and emphasize information suitable for the approaching visitor as well as increasing the degree of attraction, and therefore, more appropriate information can be demonstrated.

The difference in the characteristics resulting from the difference in the configuration between FIG. 14A to FIG. 14C is the same as that in the case of the above-mentioned distance sensor.

It requires the consent of a passerby to attach an RFID to the passerby to carry it on a general road or roadway because of the security of personal data, and therefore, it is difficult to realize the above-mentioned system, however, it is possible within a specific shop, if an RFID is attached to a point card dedicated to the shop and a shopper carries the point card.

Further, by designing the sensors 71, 72, 74 so as to be capable of detecting temperature, smoke, noise, illuminance in the vicinity thereof and causing the flexible display element 11 to bend as well as displaying an image in accordance with the detection signal, it is possible to further magnify the display effect.

For example, when the sensor is a temperature sensor, a wind-bell or waves that move toward the shore are displayed on a hot day and a bending motion is performed in accordance with a display image. Further, an advertisement of cooling beverages is displayed and a bending motion is performed.

Further, by designing the sensor as a noise sensor, it is possible to rewrite the advertisement and increase the frequency of a bending motion based on the judgment that there are a lot of passersby when the detected noise level is high. On the other hand, when the detected noise level is low, it is judged that there are few passersby and the advertisement is rewritten and the frequency of bending motion is decreased to reduce power consumption.

Furthermore, on a reflection type display medium, such as cholesteric liquid crystal, displayed information is hard to see if the illuminance is low. Because of this, the sensor is designed as an illuminance sensor and when the detected illuminance level is high, a normal image is displayed and a bending motion is performed. On the other hand, when the detected illuminance level is low, an image intended to be used when the illuminance is low stored in the storage part 23 in advance, in which the character size is large, the line is thick, and the number of colors is small, is read and displayed and at the same time, a bending motion is performed in accordance with the display image.

The modified examples in which sensors are combined are explained as above, however, there can be various kinds of sensors and various combinations.

Further, information can be expressed not only by a display but by sound. Because of this, it is possible to further increase the degree of attention when providing information by combining an acoustic apparatus with the display system in the embodiment.

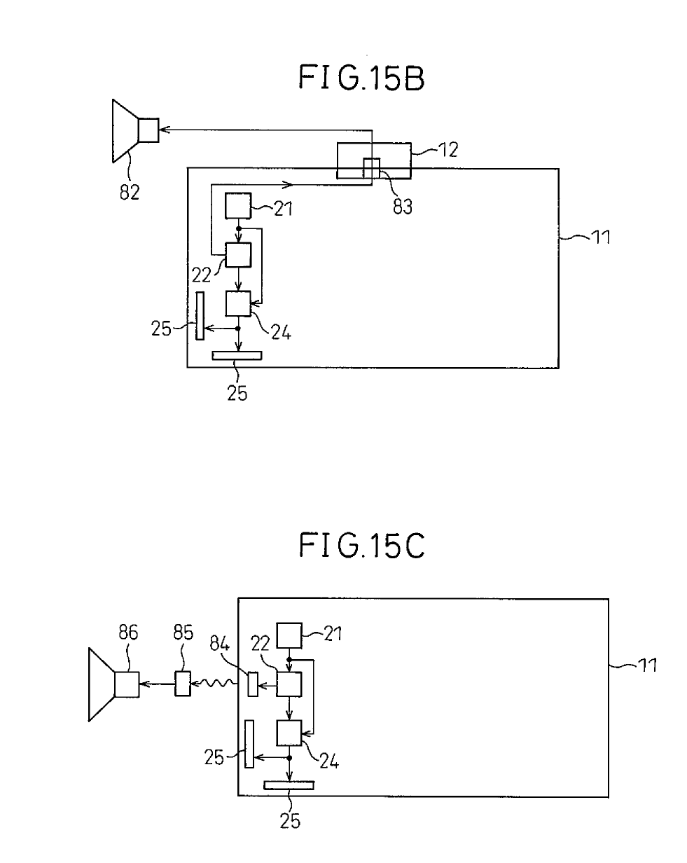

FIG. 15A to FIG. 15C are diagrams each illustrating a configuration of a modified example in which a speaker is combined with the display system in the embodiment. There can also be various modified examples according to the position at which the speaker is provided.

FIG. 15A is an example in which a speaker 81 is provided in the display device 10 (flexible display element 11). The control part 22 outputs a voice stream to the speaker 81 and the voice is output from the speaker 81.

FIG. 15B is an example in which a speaker 82 is provided outside the display device 10. The control part 22 sends a voice stream to the speaker 82 via a wired interface 83 provided in the holding member 12 that holds the flexible display element 11.

FIG. 15C shows a configuration for transmitting a voice stream to a speaker 86 from the control part 22 using a wireless interface. The display device 10 includes a wireless transmission part 84 that outputs the voice stream output from the control part 22 as a wireless signal. To the speaker 86, a wireless reception part 85 is attached, which receives the wireless signal of the voice stream transmitted from the wireless transmission part 84 and sends the received voice stream to the speaker 86.

The control part 22 reads the image data, data of bending motion and voice data stored in a storage part, not illustrated schematically, and produces a display at a timing specified by the data and performs a bending motion and at the same time, sending a voice stream to the speaker 81 at a timing associated with the timing and outputting a voice signal. Due to this, it is possible to output music in accordance with the display image and perform a bending motion of the display device 10 to the accompaniment of the rhythm of the music, and therefore, the degree of attention can be further increased.

In the examples explained so far, such as the configuration in FIG. 1A, the power source 21 is provided in the display device 10 and can be realized by a thin battery, such as a button cell. There can also be various modified examples of the power source.

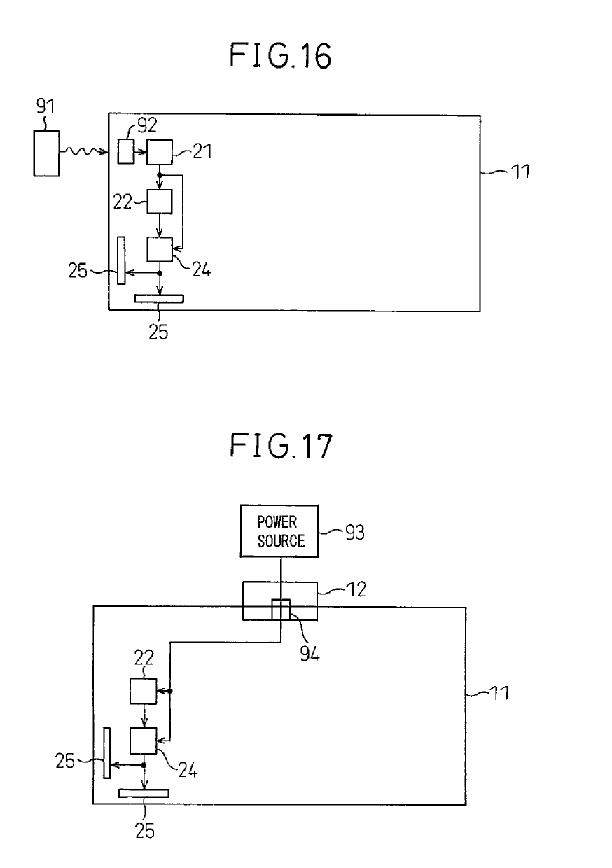

FIG. 16 shows a configuration of a modified example that utilizes the non-contact electric power supply method described in patent document 2. There is provided a base power source 91 that outputs a high frequency signal for electric power outside the display device 10. The display device 10 includes an electric power reception part 92 that receives the high frequency signal for electric power, rectifies the received high frequency signal for electric power, and generates a direct current. The electric power reception part 92 supplies the generated direct current power source to the power source 21 and the power source 21 accumulates the supplied electric power. When the accumulated electric power is running short, the base power source 91 is instructed to transmit a high frequency signal for electric power.

As illustrated in FIG. 17, it may also be possible to provide a power source 93 outside the display device 10 and supply power source to the control part 22 and the actuator drive part 24 via a wired connector 94 provided at a part in contact with the holding part 12 of the flexible display element 11. With this configuration, it is possible to increase the capacity of the power source 93 provided externally. However, it is not possible to use the conventional holding part for paper medium as it is.

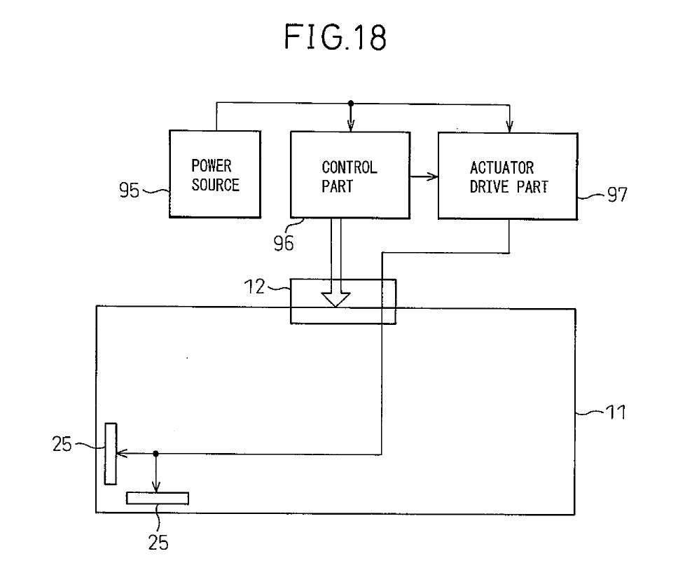

FIG. 18 is a diagram illustrating still another modified example. In the configuration in FIG. 1A, the power source 21, the control part 22, the storage part 23, the actuator drive part 24 and the actuator 25 (25A to 25D) are provided in the display device 10, however, it is also possible to, as illustrated in FIG. 18, provide only the display part and the actuator on the display element (electronic paper) 11 and provide the power source 21, the control part 22 and the actuator drive part 24 externally (the storage part is not illustrated schematically), and then write an image to the display part from a control part 96 via the wired interface provided in the holding part 12 and drive the actuator 25 by the actuator drive part 24.

As described above, the embodiments disclose a novel display element and a display system capable of further increasing the degree of attention in a display device that uses a flexible display element.

As described above, in the display device and the display system, there is provided a control part that causes a display part to perform a bending motion in accordance with an image to be displayed on the display part.

The control part is configured to cause the display part to perform a bending motion in accordance with an image, and therefore, it is possible to further increase the degree of attention.

The control part causes the display part to perform a bending motion by driving an actuator attached to the display part.

It is possible to cause the display part to bend into various shapes by attaching a plurality of actuators to the display part and causing the control part to selectively drive the plurality of actuators. Further, it is also possible for the control part to cause the display part to perform a predetermined motion by driving the plurality of actuators in an interlocking manner.

Any actuator can be used, however, an actuator that is thin, light, and consumes less power is preferable and a piezoelectric actuator or thermal distortion actuator including a monomorph or bimorph structure can be used. An actuator including a monomorph structure can bend in one direction, however, an actuator including a bimorph structure can bend in both directions.

An actuator including a bimorph structure is configured so as to include a first piezoelectric element film formed on a first electrode, a common electrode formed on the first piezoelectric element film, a second piezoelectric element film formed on the common electrode, and a second electrode formed on the second piezoelectric element film.

When image data includes an emphasized display region, if the control part causes the region of the display part corresponding to the emphasized display region to perform a motion, such as a bending motion, it is possible to further increase the degree of attention.

It may also be possible to design the configuration so that data of bending motion includes information about the magnitude of a bending motion and the control part changes the magnitude of the bending motion in accordance with an image to be displayed on the display part.

It may also be possible to design the configuration so that data of bending motion includes information about the speed of a bending motion and the control part changes the speed of the bending motion in accordance with an image to be displayed on the display part.

Further, it may also be possible to design the configuration so that a detection sensor is provided in the display device or in the vicinity thereof and the control part causes the display part to display an image in accordance with a detection signal of the detection sensor and at the same time, causing the display part to perform a bending motion in accordance with the image. Due to this, for example, it is possible to suddenly produce a display when a passerby approaches and cause the display device to bend, and therefore, it is possible to further increase the degree of attention.

When a target is a passerby including an identification element, such as RFID, it is possible to produce a display in accordance with the target and thereby increase the degree of attention by designing the configuring so that a detection sensor further detects identification information and the control part causes the display part to display an image in accordance with the identification information and at the same time, causing the display part to perform a bending motion in accordance with the image.

When the display device includes a plurality of actuators, it is possible to rock the display part back and forth by continuously shifting the bending timing at which the control part causes the display part to bend. By rocking the display part back and forth in accordance with an image to be displayed, it is possible to further increase the degree of attention.

It may also be possible to arrange an optical element, such as a Fresnel lens, on the display surface in order to make more conspicuous a bending motion.

It is necessary for the display part to be flexible and can be realized by, for example, a liquid crystal display device that includes liquid crystal including a cholesteric phase and which displays an image by switching the state between a planar state and a focal conic state.

It is necessary for the display part to be flexible and desirable to be in the form of a sheet.

It is necessary to provide a display part and an actuator to the display element, however, there can be various modified examples depending whether a power source, a control part, a storage part that stores data of bending motion corresponding to image data, an actuator drive part, etc., are provided to the display element or to a part other than the display part. There can also be various modified examples depending on the method of supplying display data, data of bending motion, and power source.

For example, the display element is provided with a storage part that stores image data and data of bending motion corresponding to the image data, and the control part reads the image data and the data of bending motion corresponding to the image data from the storage part and causes the display part to display the image data and at the same time, causing the display part to perform a bending motion based on the image data and the data of bending motion.

It is also possible to design the configuration so that an information reception part that receives an input of information from outside is provided, and the information reception part receives information including image data and data of bending motion from outside and stores it in a storage part. The information reception part receives information from outside by a wireless or wired network. Further, it is also possible for the information reception part to receive a high frequency signal from outside, rectify the high frequency signal, and use it as a power source to display an image on the display part.

If the display device is configured so as to be arranged in a suspended state, it is easy to exchange a conventional paper medium with the device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A display device comprising:
a display part that displays an image; and
a control part that causes the display part to perform a bending motion in accordance with the display image.

2. The display device according to claim 1, comprising an actuator attached to the display part, wherein
the control part causes the display part to perform a bending motion by driving the actuator.

3. The display device according to claim 2, wherein:
the two or more actuators are provided to the display part; and
the control part selectively drives the two or more actuators.

4. The display device according to claim 3, wherein
the control part drives the two or more actuators in an interlocking manner.

5. The display device according to claim 2, wherein
the actuator comprises:
a first piezoelectric element film formed on a first electrode;
a common electrode formed on the first piezoelectric element film;
a second piezoelectric element film formed on the common electrode; and
a second electrode formed on the second piezoelectric element film.

6. The display device according to claim 1, comprising a storage part that stores image data and data of bending motion corresponding to the image data, wherein
the control part reads the image data and the data of bending motion corresponding to the image data from the storage part and causes the display part to display the image data based on the image data and the data of bending motion and at the same time, causing the display part to perform a bending motion.

7. The display device according to claim 6, wherein:
the image data comprises an emphasized display region; and
the control part causes the region of the display part corresponding to the emphasized display region to perform a bending motion.

8. The display device according to claim 6, wherein:
the data of bending motion comprises information on the speed or amplitude of the bending motion; and
the control part changes the speed or amplitude of the bending motion in accordance with an image displayed on the display part.

9. The display device according to claim 1, comprising a detection sensor, wherein
the control part causes the display part to display the image in accordance with the detection signal of the detection sensor and at the same time, causing the display part to perform a bending motion.

10. The display device according to claim 9, wherein:
the detection sensor further detects identification information; and
the control part causes the display part to display an image in accordance with the identification information and at the same time, causing the display part to perform a bending motion in accordance with the image.

11. The display device according to claim 1, wherein
the control part causes the display part to rock back and forth by the bending motion.

12. The display device according to claim 1, comprising a lens arranged on the display surface.

13. The display device according to claim 1, wherein
the display part comprises liquid crystal including a cholesteric phase and displays the image by switching the state between a planar state and a focal conic state.

14. The display device according to claim 1, wherein
the display part is in the form of a sheet.

15. The display device according to claim 6, comprising an information reception part that receives an input of information, wherein
the information reception part receives information including the image data and the data of bending motion from outside and stores the information in the storage part.

16. The display device according to claim 15, wherein
the information reception part receives the information from the outside via a wireless or wired network.

17. The display device according to claim 15, wherein
the information reception part further receives a high frequency signal from outside, rectifies the high frequency signal, and uses it as a power source to display an image on the display part.

18. The display device according to claim 1, wherein
the display device is arranged in a suspended state.

19. A display system comprising:
a storage part that stores image data and data of bending motion corresponding to the image data;
a transmission side device comprising a data transmission part that transmits the image data and the data of bending motion stored in the storage part to a display device;
a reception part that receives the image data and the data of bending motion from the data transmission part;
a display part that displays an image corresponding to the image data; and
a control part that causes the display part to perform a bending motion in accordance with the data of bending motion.

20. The display system according to claim 19, wherein
the transmission side device and the display device are connected via a wireless or wired network.
